(19) United States
(12) Patent Application Publication
(10) Pub. No.: US 2022/0205211 A1
(43) Pub. Date: Jun. 30, 2022

(54) SYSTEMATIC PROTECTING AND UTILIZING METHOD FOR HILL RESOURCES

(71) Applicant: Baofu Sheng, Shanghai (CN)

(72) Inventor: Baofu Sheng, Shanghai (CN)

(21) Appl. No.: 17/605,246

(22) PCT Filed: Nov. 5, 2020
(86) PCT No.: PCT/CN2020/126752

§ 371 Date: Oct. 21, 2021

(51) Int. Cl. E02D 29/02; A01B 79/02

(52) U.S. Cl. CPC E02D 29/0225; A01B 79/02

(57) ABSTRACT

The present disclosure provides a method of systematic protection and utilization of hill resources, and relates to the field of protection and utilization of hill resources. The method of systematic protection and utilization method of the hill resources comprises a hill resource protection method and a hill resource utilization method. The hill resource protection method comprises a prevention and control method for geological disasters such as landslide, debris flow, water and soil loss, fire disasters and/or desertification caused by earthquakes, rainstorms and/or drought and the like, and a prevention and control method for continuous weathering of mountain rocks; and the hill resource utilization method is a method for utilizing available resources generated based on the protection. According to the method of systematic protection and utilization for hill resources, a foundation for utilizing the hill resources is built by protecting the hill resources, with protection and utilization integrated. Compared with existing methods, the method provided by the present disclosure not only can prevent and control natural disasters, protect the hill resources and prevent water and soil loss, but also can efficiently utilize water and soil resources, increase the output value, relieve the cultivated land pressure and promote industrial layout adjustment.

### TECHNICAL FIELD

The present disclosure relates to the technical field of protection and utilization of mountain and hill resources (hereinafter referred to as hill resources), and specifically, to a method for systematic protection and utilization of hill resources.

### BACKGROUND ART

Land resources and water resources are limited natural resources, “distribution ratio of the mountain, water and farmland being 3:6:1” represents the distribution situation of the earth resources, which also reveals the dilemma of shortage of cultivated land resources. Large population, coupled with the scarcity of cultivated land resources, has caused serious food security problems. Due to limitations in terms of science and technology, financial investment and other factors, enough attention has not been paid to the scientific protection and utilization of hill resources. As a result, a large amount of hill resources are not effectively protected, and meanwhile, there are serious geological disasters, such as landslide, debris flow, water and soil loss, fire disasters and/or desertification, caused by earthquakes, rainstorms and/or drought and the like, which bring about huge losses to the lives and properties of people in the relevant areas. Obviously, their utilization is not put in consideration.

According to the investigation of the inventor, there is a universal unidirectionality in the current protection and utilization of hill resources, that is, a single protection or unilateral utilization that stays in a micro area, rather than systematic protection and scientific utilization, which objectively leads to the situation that the protection of the hill resources is not in place and the utilization thereof is unreasonable.

In view of this, it is particularly important to invent a highly scientific method of systematic protection and utilization of hill resources.

### SUMMARY

The purpose of the present disclosure is to provide a method for systematic protection and utilization of hill resources, which can simultaneously realize disaster management, and protection and scientific and reasonable utilization of resources and the like.

The present disclosure is achieved by the following implementation steps.

A method for systematic protection and utilization of hill resources, with the development idea for systematic protection and utilization of hill resources, includes the protection method of hill resources and the utilization method of hill resources. The method of protecting hill resources completes the protection of hill terrain, such as drainage for flood diversion, water collection, irrigation and/or hill consolidation and scientific utilization based thereon by developing and improving functions of arranging a “mountain road drainage and slope protection system” (Patent No.: ZL 2017209773447) in a target area and being grounded in the whole field.

Further, the distribution of the “mountain road drainage and slope protection system” follows the core principles of the overall planning, wherein from the top of the mountain down along the slope, according to the shape of the side ridge of the mountain and the principle of contour lines, the water collection roads, water diversion channels and/or water collection ponds are constructed step by step. Through the water collection roads and/or water diversion channels and the water collection ponds, a waterway network system is formed in which roads are connected with ponds, and there are large areas of roads and water.

Further, the water collection roads in the “mountain road drainage and slope protection system” are connected with the inclined protection slopes and/or a plurality of integrated curb blocks to form a self-contained body, wherein the road surfaces are provided with horizontal water collection ditches and water collection net covers, the roads are constructed according to the principle of “contour line”, with the inner sides being slightly lower and blocking the water layer by layer, which weakens the ability of rainstorm forming converged water, namely, both collecting water resources layer by layer and avoiding the loss of soil; and inclined protection slopes is used to block the direct contact between the rock wall and the air, preventing the exposed rock wall from continuous weathering.

The method for utilization of hill resources realizes the effective utilization of the land resources of the hills, by scientifically developing and utilizing the available resources generated when performing systematically protection on the hill resources, collecting and utilizing abundant rainwater in the rainy season, and laying out the primary industry, the secondary industry and the tertiary industry based on the “mountain road drainage and slope protection system” that has been built.

Further, the layout of the primary industry follows the principles of the cycle between planting and breeding, combination of advantages of all elements, saving of production cost and/or scalization, and focuses on the establishment of the main links in the circular industry chain. With intensive aquaculture and large-scale planting as the two basic main bodies, specific planting and breading varieties are selected according to the characteristics of the county and the characteristics of the varieties.

Further, the layout of the secondary industry is based on the principle of increasing the industrial value of the primary industry. The selection of the main body of the secondary industry should focus on the combination with the deployment of the primary industry, and based on the established planting and breeding industries, the upstream and downstream of the industry chain should be expanded, linked, optimized and improved to form a complete circular chain.

Further, the layout of the tertiary industry is to build a platform of product supply, exhibition and sales on the basis of the established primary and secondary industries to fully serve the primary and secondary industries; and strengthen the development theme of combining agriculture and tourism, follow the principles of taking agriculture as the foundation, increasing tourism value, promoting tourism by agriculture, and enriching agriculture by tourism, increase the tourism elements of the primary industry and the secondary industry, meanwhile, expand the science and education themes of the tourism industry, and realize the integrated development of the primary, secondary and tertiary industries.

The present disclosure has the following beneficial effects.

The present disclosure provides a method for systematic protection and/or utilization of hill resources. Based on the background that geological disasters in hilly areas frequently occur which endangers the safety of people's lives and causes property losses, it proposes methods for the integration and promotion of hill geological disaster management, the protection of hill resources and utilization of hill resources, that is, the protection of hill resources is achieved by sorting out the geological structure of the hills with water and soil protection as the core, to avoid the occurrence of serious geological disasters such as landslide, debris flow, water and soil loss, fire disasters and/or desertification. Based on this, by building the foundation for industrial layout and development through organization of the hill resources, the available hill resources are comprehensively utilized.

As for the prevention and control of geological disasters, it can realize the prevention and control of natural disasters such as landslides and/or mudslides caused by heavy rains, realize the protection of water and soil resources, reduce water and soil loss, prevent land desertification, and play a role in the prevention and nearby rescue of the mountain forest fires, thus comprehensively guaranteeing the safety of relevant people's lives and property.

As for the utilization of hilly water and soil resources, based on the available water and/or soil resources formed during the protection of hill resources, targeted large-scale transfer of primary industry, secondary industry and tertiary industry to hilly areas can not only effectively alleviate the pressure of cultivated land, but also promote the development of the surrounding economy through the layout and development of related industries, and greatly increase the output value of remote and poor mountainous areas.

At the same time, the non-three major staple foods planting industries are moved from plain cultivated lands to hillside lands, and the plain cultivated lands are used for the planting of three major staple foods to ensure the maximum planting area of the three major staple foods and greatly increase grain yield.

The method for systematic protection and utilization of hill resources provided by the present disclosure can not only realize advanced treatment and protection of hill resources, but also comprehensively utilize available hill resources generated in the process of the protection. Based on the topography and geomorphology, “a mountain road drainage and slope protection system” is used on the hills to realize the arrangement and protection of the hill resources, the primary industry, secondary industry and tertiary industry are laid out based on combination of regional characteristics and mountain topography and integrated with the circular industry chain to realize the development and utilization of hill resources. Compared with the existing methods, the method for systematic protection and utilization of hill resources provided by the present disclosure will realize the protection of hill resources and further comprehensive utilization, and has a practical significance in disaster management, and resource protection, development and utilization.

### DETAILED DESCRIPTION OF EMBODIMENTS

In order to make the objectives, technical solutions and advantages of the embodiments of the present disclosure clearer, the technical solutions in the embodiments of the present disclosure will be described clearly and completely in conjunction with specific embodiments of the present disclosure. Obviously, the described embodiments are some of the embodiments of the present disclosure, but not all of the embodiments. The industries of the embodiments of the present disclosure described and illustrated herein may generally be arranged and designed in a variety of different configurations. Therefore, the following detailed description of the embodiments of the present disclosure provided is not intended to limit the scope of the claimed present disclosure, but merely represents selected embodiments of the present disclosure. Based on the embodiments in the present disclosure, all other embodiments obtained by those of ordinary skill in the art without creative work shall fall within the protection scope of the present disclosure.

This method is not an innovation at the theoretical level, but a summary of experience discovered based on a large number of development practices. In the following, some embodiments of the present disclosure will be described in detail with reference to examples. In the case of no conflict, the features in the following embodiments can be combined with each other.

The example is a hilly modernized agricultural development project of Renshou Jinghu Mountain Villa Agricultural Development Co., Ltd. The project region is located in Baofeng Village, Aoling Township, Renshou County, Sichuan Province, wherein 6000 acres of transferred barren hills and stone valleys are contracted.

First, according to the mountain topography, “a mountain road drainage and slope protection system” is laid, and the main roads are constructed along the side ridge of mountains. When encountering a mountain stream, a pond is constructed according to the terrain, and the roads are horizontally provided with water collection ditches as required to block the rainwater collected on the water collection roads, and the collected rainwater is introduced into the pond through the water diversion channels.

Then, based on the laid “mountain road drainage and slope protection system”, the hilly land consolidation is carried out, wherein the flat region is used for construction, while the steep region is used for planting. On the one hand, a modernized breeding farm for 720,000 laying hens during molting is chosen to be built, and nowadays, there are 260,000 laying hens during molting in stock, 18 tons of eggs produced per day, and annual output value of 65 million. On the other hand, the planting follows the three-dimensional planting principles of performing greening on steep slopes, planting fruit forests at sunny slopes, constructing landscapes at shady slopes, and planting shrubs at bottoms, wherein planting grass is replaced by forage mulberry (forage mulberry can be used as a functional feed for laying hen breeding to improve the quality of eggs and meat, and also has the slope protection function of protecting water and soil, and as for planting on hillsides, mechanical harvesting may also be used), and fruit trees (sunny slopes) and landscape trees (shady slopes) suitable for local growth are planted thereon to complete the improvement of the slopes of barren hills.

Afterwards, the circular industrial chain of “planting and breeding” can be improved based on clear modern breeding of laying hens and large-scale planting of forage mulberry, fruit trees and/or landscape trees. First, the project regions are all weathered stone soil, full of barren hills and valleys with thorns, weeds and vines, so following the principle of planting and breeding cycle, organic fertilizer production plants and biogas power stations are built nearby to perform processing treatment on the manure generated by the breeding farms, which can not only solve the problem of pollution, but also provide high-quality organic fertilizer for the project planting, and also utilize biogas to generate power for solving the power consumption problem of the whole project. Second, based on the large-scale planting of forage mulberry, feed processing plants are built to process the forage mulberry nearby, so as to provide high-quality feedstuff for breeding projects, thus realizing effective connection of the planting and breeding and completing the construction of the circulation chain.

Then, glass sightseeing corridors are added based on the construction of workshops of the modern laying hen breeding farm, and “a tail gas recycling and reutilizing system” (which has entered the substantive examination stage of invention patent, hereinafter referred to as tail gas system) is added at a tail. In the above, the tail gas system can utilize the waste heat of tail gas to dry silage, and process the harmful gases in the tail gas through the filter water nets and the greenhouses, so that the breeding farm has no emission and no pollution at all, and at the same time the additional output value is increased. The breeding industry base is built according to tourism standards, so as to get rid of the label of “dirty, messy and poor”, and becomes a scientific research and popular science base.

Afterwards, based on the various products produced by the project, an agricultural product exhibition and sales platform may be built, the largest agricultural product trading center in areas of greater Chengdu may be built, and accompanied with warehousing and logistics services, which can provide one-stop services of production, supply and marketing of agricultural products.

Then, the general aviation industry can be developed by taking advantage of the hill terrain, wherein general aviation airports and training centers are built for cultivating a large number of general aviation talents. The utilization of hill resources to develop the industry can avoid the occupation of limited cultivated land by the general aviation industry from the beginning, and promote the effective release of cultivated land. At present, the project has completed the planning and design of the general aviation airport and general aviation training building, and the general aviation airport runway is under construction.

Finally, with the help of general aviation, modern breeding and large-scale planting industry, we can provide the rural leisure tourism, such as sightseeing from helicopter, educating bases of modern planting, and the gourds/fruit picking along the contour line gourds/fruit trail, which can help selling the farm products, promote the development of the surrounding economy, and upgrade from poverty alleviation through industries to prosperity through agricultural tourism.

The above are only preferred embodiments of the present disclosure, and are not intended to limit the present disclosure. For those skilled in the art, the present disclosure may have various modifications and changes. Any modification, equivalent replacement and/or improvement made within the spirit and principle of the present disclosure shall be included in the protection scope of the present disclosure.

What is claimed is:

1. A method for systematic protection and utilization of hill resources, used for systematic protection of the hill resources and scientific utilization of available resources generated during the protection process, comprising both a method for protection of the hill resources and a method for utilization of the hill resources, wherein the method for protection of the hill resources completes the protection of hills through layout and the laying of “a mountain road drainage and slope protection system” in a target area, and the method of utilization of the hill resources achieves utilization of the available resources generated in the protection process through scientific layout of a primary industry, a secondary industry and a tertiary industry;
the “mountain road drainage and slope protection system”, which has successfully applied for a utility model patent (ZL; 2017209773441), has layout thereof in the target area following a core principle of global coordination, in which the building is performed from tops of mountains down along slopes to achieve layered water interception, and at the same time, sending intercepted rainwater to nearby ponds; and
site selection of the ponds in the “mountain road drainage and slope protection system” conforms with topographical features of mountain slopes, wherein water-converged low-lying places of mountain steams are selected, and used to store a large amount of rainwater collected by footpaths.

2. The method for systematic protection and utilization of hill resources according to claim 1, wherein the utilization of hill resources is based on the protection of hill resources, that is, the utilizable hill resources are produced during implementation of protection processes, and the utilization also follows scientific planning.

3. The method for systematic protection and utilization of hill resources according to claim 1, wherein the utilization of available resources must follow a layout idea of integrated development of the primary industry, the secondary industry and the tertiary industry, so as to realize inter-industry linkages, mutual feeding, mutual promotion and coordinated development.

4. The method for systematic protection and utilization of hill resources according to claim 3, wherein completion of environmental protection on details is paid attention to, for example, a tail gas recycling and reutilizing system is installed at tails of breeding farms in the primary industry and workshops of the secondary industry, depending on whether tail gas is generated or not, so as to absorb waste gas generated from breeding and prevent the waste gas from polluting air from root cause (the example here is provided for ease of understanding, but is not intended to limit the scope of the claimed present disclosure); and
the tail gas recycling and reutilizing system is provided with constant-temperature ecological greenhouses, configured to utilize waste heat of the tail gas to expand a range of a planting industry in the primary industry.

5. The method for systematic protection and utilization of hill resources according to claim 4, wherein as for the completion of environmental protection on details, completion of an industrial chain is taken as a basic starting point, that is, circulation of the industrial chain is completed by solving pollution problems existing in operation processes of the three industries, realizing resourcfulization of pollution, for example, frogs are pasture-raised to eliminate mosquitoes and flies in the breeding farm (example is provided for ease of understanding, and is not intended to limit the scope of the claimed present disclosure).

6. The method for systematic protection and utilization of hill resources according to claim 1, wherein the water collection roads of “a mountain road drainage and slope protection system” comprise a water collection main roads, a water collection footpaths and water collection channels, which are configured to play roles of rainwater collection, water transferring and irrigation, wherein the water collection main roads and the water collection footpaths are further configured to play a role of mountain traffic, and
the water collection footpaths are all constructed in accordance with a principle of contour lines, and built with support frames for climbing of vine-type plants, to make use of space above the footpaths.
